(19) United States
(12) Patent Application Publication
(10) Pub. No.: US 2025/0033713 A1
(43) Pub. Date: Jan. 30, 2025

(54) Automobile Aerodynamics and Mirrors, Solar Down Force

(71) Applicant: Francis Xavier Gentile, Los Angeles, CA (US)

(72) Inventor: Francis Xavier Gentile, Los Angeles, CA (US)

(21) Appl. No.: 18/676,165

(22) Filed: May 28, 2024

Related U.S. Application Data
(60) Provisional application No. 63/504,755, filed on May 29, 2023.

(51) Int. Cl. B62D 35/00

(52) U.S. Cl. CPC B62D 35/005

(57) ABSTRACT

Systems, methods, kits, and devices for increasing or changing downward force on moving vehicles are contemplated. An extension panel is coupled to the front of a car at the front hood, the windshield, or both, and extends over the roof of the car. The extension panel increases surface area of the front of the vehicle and increases downward force on the vehicle. More than one panel can be coupled to the front, windshield, roof, or rear end of the car to increase downward force. Panels coupled to the roof or above the windshield can be adjusted by a hinge to increase or decrease downward force. Solar panels can also be integrated in extension panels to generate electricity.

This application claims the benefit of priority to U.S. provisional application No. 63/504,755 filed on May 29, 2023. This and all other extrinsic references referenced herein are incorporated by reference in their entirety.

### FIELD OF THE INVENTION

The field of the invention is vehicle aerodynamics.

### BACKGROUND

Lift upward on an automobile is bad. One does not want ones vehicle take off into the air. Lift induces work which creates drag which increases the energy consumed to propel the car. A car experiencing lift gets more becomes harder to control as its air speed increases. The car becomes lighter in reference to the ground at the same time that the cars momentum or inertial weight or force is increasing. Therefore at some point you cannot stop or steer the car in its intended path. The intended path may be straight, but with a gust of wind from a vehicle passing in the opposite direction. The path may be around a corner. The path may be down a long hill, where brakes overheat. Or combinations of all of the above. If the air flow in the car itself detaches from the car in a changing way, an unpredictable way, then the car will be unpredictable steered in unintended, undesirable ways.

It is necessary to see out the front and back windows in a car. The sloped windows on existing cars attempt to compromise between seeing out the windows, and reducing aerodynamic drag. The unfortunate result is a curved shaped airflow that generates lift in the same way as the upper side of a cambered airfoil. This may vary as the flow may not stay smooth and at a constant distance from the car at all times. The flow may be turbulent.

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

These patents refer to the semi circular planform shape in aircraft use: U.S. Pat. Nos. 8,016,225, 2,431,293A, 2,108,093A, 2,462,824A, 2,438,309A.

Patents by Beckon, controllable surfaces on vehicle roof of many kinds: U.S. Pat. Nos. 2,438,309A, 8,740,285B2.

Patents by Hicks, on vehicle roof seeking uplift: US20120007388A1, U.S. Pat. No. 8,757,700B2.

Patents by Shang, on vehicle roof seeking lift upward and downward: U.S. Pat. No. 6,338,524B1.

Patents by Sherai, Toyota, on vehicle roof camera and simple deflector: US20160236725A1.

Those patents are associated with a passenger car towing a trailer to deflect air: U.S. Pat. Nos. 3,596,974A, 3,794,372A.

Many patents are associated with trailer trucks, here are some most similar: U.S. Pat. Nos. 4,102,548A. 4,462,628A, 4,458,937A.

Other teachings include USRE19412, DE102010019300A1, U.S. Pat. No. 8,424,957B2, DE202004020599U1, DE102005025363A1, DE202013007447U1, and DE202013008943U1.

Thus, there is still a need for adjusting aerodynamics of moving vehicles to increase or otherwise change downward force on the vehicle.

### SUMMARY OF THE INVENTION

A goal herein is to keep the flow of air, atmosphere, fluid, or other medium through which a vehicle traverses more predictable and constant. A goal herein is to eliminate upward lift. A goal here is to see out the windows. A goal here is to at least avoid increasing energy consumed to propel a car or vehicle. A goal here is to avoid increasing aerodynamic drag in one of or all of its forms; lift induced, form and profile drag, detached flow, turbulence etc. A preference here is to trade the upward lift of existing designs for downward lift referred to as ‘downforce’. Adjustability of the aerodynamics with user control or active control slaved to steering and brakes may be practical and desirable.

The curved upper side of passenger vehicles car directs airflow downward to create upward lift on the car. This design condition may have been previously associated with the necessity of seeing our rear windows.

Here we seek to eliminate upward lift on the car and substitute downward lift on the car, and provide shade for the car rear windows and provide surfaces for solar electrical generation cells, without blocking rearward vision through existing windows.

This is accomplished using a starting with the edge of the front windshield middle of the vehicle low aspect Zimmerman rearward semicircle planform which sends two shed vortices colliding under the planform and upward filling the vehicles lee side with energized directed air. Ideally this would create downward lift while reducing the lift induced drag and shape drag that previously existed without the new planform.

The necessity of supporting the new planform against large air loads could be used to double purpose to use the support structures to achieve further aero-improvements, including:

Longitudinal L or R extrusions or shapes in the middle of the platform which protrude upward through the solar panel materiel they support, there by creating a fence spoiler against cross winds gaining lift on the upper surface of the planform. It should be appreciated that solar cells of known technologies can be applied to or integrated into surfaces of the vehicle, including the extension, panels, fins, spoilers, or fences described herein.

L type extrusions or shapes can be used around the side and possibly the rear of the periphery of the planform to sharply and forcibly shed any attached flow to therefore provide better vortices formation and to structurally stiffen the otherwise sharp thin edges of a solar cell sheet or any surface of the vehicle. This is sometimes known as a Gurney Flap after its inventor Dan Gurney, although other approaches are taught such as E. F.-ZAPARKA Re. 19,412 Aircraft And Control Thereof, Jan. 1, 1935.

Methods, devices, systems, and kits are contemplated to adjust or change aerodynamics of a vehicle, preferably by altering or increasing the downforce on the vehicle when the vehicle is in motion. A kit is contemplated to adjust acrodynamics of a vehicle having a body, a front hood, and a windshield. The kit includes a panel adapted to couple with the vehicle at the front hood. The first panel extends away from the front hood for a length at least 5% of a width of the front hood. Another panel is adapted to couple with the vehicle about the windshield. The second panel extends away from the windshield for a length at least 5% of a width of the windshield.

Further kits or sets of devices is contemplated for adapting a vehicle to increase downward force of the vehicle moving in a motive vector. A first panel having a primary surface is adapted to couple to the vehicle. When coupled to the vehicle, primary surface has a normal vector of 60° of the motive vector, in some embodiments between 10° and 80°, between 20° and 70°, between 30° and 60°, or about 45°. A support is coupled to the first panel having an end configured to couple to the vehicle, preferably adjustably.

The first panel is configured to couple to the vehicle at one of a hood, a trunk, a door frame, a windshield, or a roof of the vehicle, though it is contemplated the first panel can couple at other rails or mounts (e.g., roof racks, bike rake, tow hitch), or fixtures or features (door handles, headlights, antenna, etc.) of the vehicle. The end of the support is also configured to couple to the vehicle at one of a hood, a trunk, a door frame, a windshield, or a roof of the vehicle. Preferably, the first panel is rotatably coupled to the vehicle, for example via a hinge, pivot, extendable arm, or flexible coupling. The support is adjustable (e.g., rotatable, extendable, etc.) and provides an angle of 5° to 60°, less than 45°, less than 30°, or between 5° and 20° between the first panel and a surface of the vehicle.

Methods of modifying a vehicle to adjust vehicle aerodynamics are further contemplated. A first panel is coupled about or around a windshield of the vehicle. The first panel has a surface extending away from the windshield, for example extending at least 6 inches, 1, 2, or 3 ft away from the windshield. A second panel is coupled to the front hood, the roof of the vehicle, or the rear end or trunk of the vehicle. Preferably the second panel is within 20° or between 5° and 30° of parallel to the first panel. A support is coupled to the first panel or the second panel (or both), and further coupled at an end to the vehicle, thus providing support to the panel and adding transfer of downward force from the panel to the vehicle. A fin or other panel can be coupled to the roof or the rear end of the vehicle, for example over the back hatch or trunk, or over the back end of the vehicle.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 depicts a view of the flow of air around a vehicle.

FIG. 2 also depicts a view of the flow of air around a vehicle.

FIG. 3 depicts a view of a vehicle.

FIG. 4 depicts another view of a vehicle.

FIG. 5 depicts a vehicle with an adjustable support strut.

FIG. 6 depicts an adjustable support strut.

FIG. 7 depicts a flat curveable sheet on a vehicle.

FIG. 8 depicts a view of a vehicle.

FIGS. 9A-9D depict example views of a vehicle.

FIGS. 10A-10B depict further views of a vehicle.

FIGS. 11A-11B depict views of a vehicle.

FIG. 12 depicts a trailer.

FIGS. 13A-13C depict views of a vehicle with roof frame.

FIG. 14 depicts a roof frame.

FIG. 15 depicts a vehicle having features of the inventive subject matter.

FIG. 16 depicts another vehicle having features of the inventive subject matter.

FIG. 17 depicts yet another vehicle having features of the inventive subject matter.

FIG. 18 depicts a further vehicle having features of the inventive subject matter.

FIG. 19 depicts a further vehicle having features of the inventive subject matter.

FIG. 20 depicts another vehicle having features of the inventive subject matter.

FIG. 21 depicts yet another vehicle having features of the inventive subject matter.

FIG. 22 depicts still another vehicle having features of the inventive subject matter.

FIG. 23 depicts a vehicle having features of the inventive subject matter.

FIG. 24 depicts a further vehicle having features of the inventive subject matter.

FIG. 25 depicts another vehicle having features of the inventive subject matter.

FIG. 26 depicts yet another vehicle having features of the inventive subject matter.

FIGS. 27A-C depict views of other vehicles having features of the inventive subject matter.

FIGS. 28A-D depict views of yet other vehicles having features of the inventive subject matter.

FIGS. 29A-D depict views of still other vehicles having features of the inventive subject matter.

FIGS. 30A-F depict views of more vehicles having features of the inventive subject matter.

### DETAILED DESCRIPTION

Methods, systems, kits, and devices of the inventive subject are contemplated. Devices for use on vehicles or methods of adapting vehicles are contemplated. The plane or curved shape of the front transparent windshield (usually glass, plastic, or other transparent material) of a vehicle, and the slope of the windshield, is continued upward as an extension or panel out of same or different materiel, to above and beyond the preexisting common roof of the vehicle. The extension or panel terminates in a sharp edged semicircular shape. In some embodiments the semicircular shape extends sidewards to cover the width of vehicle side mirrors. The panel or extension creates an increasing and diverging gap and space between the back, rearward, aft side of the new additional plane and the car's roof. The panel or extension continues upward and away from the roof and windshield until it ends in a sharp, narrow, sudden, tripped, gradual, or serrated edge semi-circular or semi elliptical in shape.

In some embodiments an adjustable or hinged angle at the point of forward attachment between the panel or extension and the vehicle is included. The angle relative of the panel or extension relative to the plane of the front windshield window can be varied with such hinge or adjustable element. Adjustable support or supports can further be coupled behind panel or extension to accomplish the changeable angle or otherwise aid in supporting the panel or extension. The adjustability may be remotely powered or controlled, or manually effected. The extension of a conventional windshield could be slanted back or more upright relative to the existing conventional windshield plane which it continues from.

The extension or panel can further have its semicircular shape extended sideward and downward in the port and starboard directions to encompass and or combine with the functions of the side external mirrors of the car. The extension can extend beyond or over the side of the vehicle body, or match the shape of the vehicle body while extending from the body.

Each element of the described embodiments can be viewed separately and combined with one or more whole or partial elements of one or more other embodiments described herein.

Methods, devices, systems, and kits are contemplated to adjust or change aerodynamics of a vehicle, preferably by altering or increasing the downforce on the vehicle when the vehicle is in motion. A kit is contemplated to adjust aerodynamics of a vehicle having a body, a front hood, and a windshield. The kit includes a panel adapted to couple with the vehicle at the front hood. The first panel extends away from the front hood for a length at least 5% of a width of the front hood, or at least 10%, 15%, 25%, 50%, or more than 75% a width of the front hood. Another panel is adapted to couple with the vehicle about the windshield. The second panel extends away from the windshield for a length at least 5% of a width of the windshield, or at least 10%, 15%, 25%, 50%, or more than 75% a width of the windshield.

The second panel can be an extension of the first panel, can be separate and independent of the first panel, or can be coupled to the first panel. The first panel can be coupled to the second panel at a boundary corresponding to a seam, joinder, or meeting of the front hood and the windshield. The first panel is typically co-planar with the second panel, shares a curvature of the second panel, or is within 5°, 10°, 20°, 30°, or 45° of parallel with the second panel. In some embodiments the first panel includes a solar panel.

The first panel couples to an exterior surface of the vehicle body at or near (e.g., adjacent to, proximal, within 1, 2, or 3 ft, etc.) the front hood, a front wheel well of the vehicle, or a headlight of the vehicle. In some embodiments the first panel replaces the front hood of the vehicle (e.g., covers the engine compartment or frunk compartment). The first panel can also include a gap configured to fit the body of the vehicle about the front hood, for example fit around and extend away from the hood or side body of the vehicle.

The second panel can integrate a transparent panel, such that the transparent panel replaces the windshield of the vehicle. The second panel can also include a hinge allowing a top portion of the second panel to rotate away from the top portion of the vehicle. The second panel can extend over a side view mirror of the vehicle, or both side view mirrors, or extend over and away from a roof of the vehicle at an angle of at least 5°, 10°, 20°, 30°, or 60° to the roofline. In some embodiments the second panel includes a solar panel.

Further kits or sets of devices is contemplated for adapting a vehicle to increase downward force of the vehicle moving in a motive vector. A first panel having a primary surface is adapted to couple to the vehicle. When coupled to the vehicle, primary surface has a normal vector of 60° of the motive vector, in some embodiments between 10° and 80°, between 20° and 70°, between 30° and 60°, or about 45°. A support is coupled to the first panel having an end configured to couple to the vehicle, preferably adjustably.

The first panel is configured to couple to the vehicle at one of a hood, a trunk, a door frame, a windshield, or a roof of the vehicle, though it is contemplated the first panel can couple at other rails or mounts (e.g., roof racks, bike rake, tow hitch), or fixtures or features (door handles, headlights, antenna, etc.) of the vehicle. The end of the support is also configured to couple to the vehicle at one of a hood, a trunk, a door frame, a windshield, or a roof of the vehicle. Preferably, the first panel is rotatably coupled to the vehicle, for example via a hinge, pivot, extendable arm, or flexible coupling. The support is adjustable (e.g., rotatable, extendable, etc.) and provides an angle of 5° to 60°, less than 45°, less than 30°, or between 5° and 20° between the first panel and a surface of the vehicle.

The first panel is configured to couple about or around a windshield of the vehicle and extend over a roof of the vehicle (e.g., U-shaped extending around and over windshield. A second panel can further be configured to couple to one of a roof, a rear end, or a front hood of the vehicle along with or separate from the first panel.

Methods of modifying a vehicle to adjust vehicle aerodynamics are further contemplated. A first panel is coupled about or around a windshield of the vehicle. The first panel has a surface extending away from the windshield, for example extending at least 6 inches, 1, 2, or 3 ft away from the windshield. A second panel is coupled to the front hood, the roof of the vehicle, or the rear end or trunk of the vehicle. Preferably the second panel is within 20° or between 5° and 30° of parallel to the first panel. A support is coupled to the first panel or the second panel (or both), and further coupled at an end to the vehicle, thus providing support to the panel and adding transfer of downward force from the panel to the vehicle. A fin or other panel can be coupled to the roof or the rear end of the vehicle, for example over the back hatch or trunk, or over the back end of the vehicle. Additional panels or fins can include solar panels.

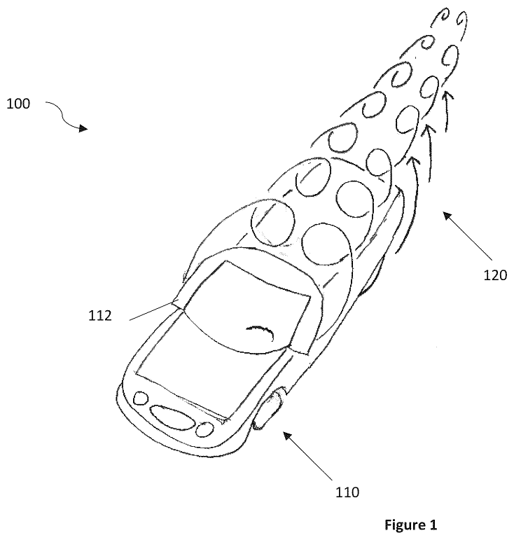

FIG. 1 depicts a view of vehicle 100 having body 110, visualizing the flow of air 120 with colliding vortices around the modified vehicle 100 around the windshield window downforce and mirror covering extension 112. This extension 112 could be a separate piece that is just the difference from a conventional windshield or it could be a single piece of a new larger window, or it could be a single piece that is overlaid the existing conventional windshield.

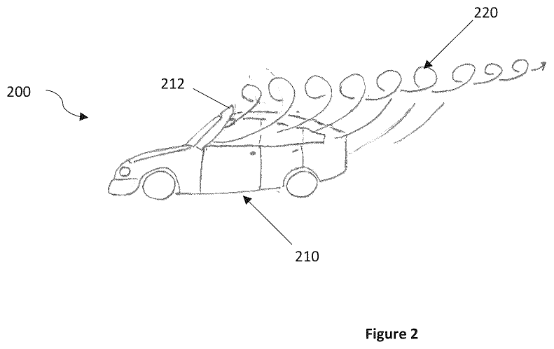

FIG. 2 depicts a side view visualizing the flow of air 220 the around modified vehicle 200 having body 210. Air flow 220 is around the windshield window downforce and mirror covering extension 212, which extends around, above, and away from the windshield and broadens the downforce surface of vehicle 200.

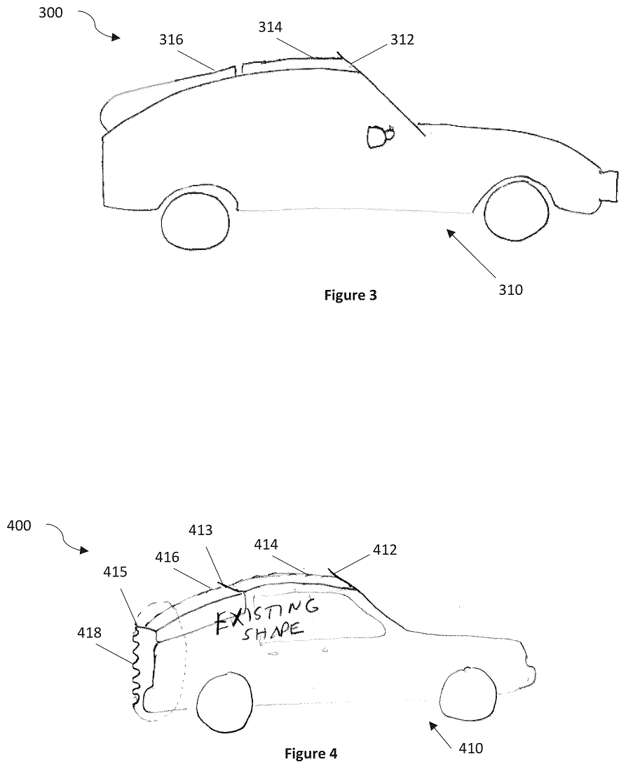

FIG. 3 depicts a side view of vehicle 300 with body 310, where a cross wind lift spoiling fence 314 or spoiler 316 is in place acting to hold integral antennas or support the windshield window downforce and mirror covering extension 312 with a Flexible wire antenna or antennas laced in spoiler panels and with said antenna or antenna wire flexibly adapting to the opening change in angle of a hatchback door.

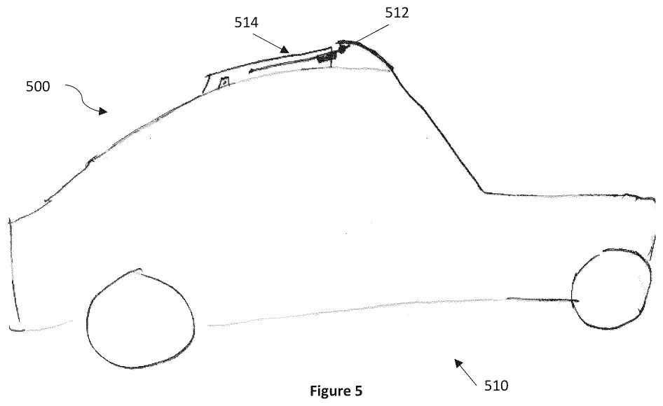

FIG. 4 depicts a side view of vehicle 400 having body 410 and extension 412. Crosswind lift spoiling fences 414 and 416 hold integral antennas of vehicle 400. Fence 414 further supports the windshield window downforce and mirror covering extension 412 with a flexible wire antenna or antennas laced in spoiler panels (e.g., at 412, 413, or 415) and flexibly adapting to the opening change in angle of a hatchback door that contains more spoiler (e.g., 413 or 415) and the same antenna extended and spanning between roof spoiler (413) and hatchback spoiler (415). Or more, smaller, or different antennas or spoilers can be included or added. 414 or 416 can be centered on the vehicle (e.g., centered between side mirrors) or having two or more lined in parallel and evenly aligned across the width of vehicle 400. Trailing edge extension definer 418 can be coupled to spoiler 415. 418 is scalloped, serrated, blunted shape, or rounded tip, and can be made of soft or semi-soft material, as well as clear or transparent.

FIG. 5 depicts vehicle 500 having body 510 with an adjustable support strut assembly 514 wherein adjustable strut assembly 514 changes the characteristic of windshield window and mirror covering extension 512 by bending it flexibly. Strut assembly 514 or extension 512 can be adjusted by hinges or flexing portions. Strut assembly 514 can include a linear actuator to pull and push on extension 512 (e.g., the whole extension, one or more individual parts or panels of the extension, etc.) to change the angle of extension 512 or a panel or part of the extension. The linear actuator can be aligned next to or integrated into extension 512 or a part thereof (e.g., a spoiler, a fin, a crosswind spoiler fin, etc.).

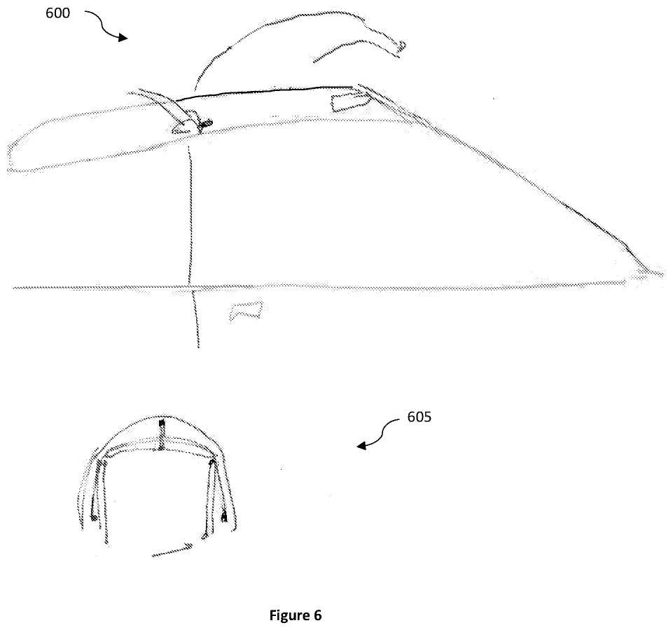

FIG. 6 depicts a sketch 600 of an adjustable support strut and a control system 605 of assembly 514 and extension 512. A loop of cable-operated angle control of a part of extension 512 (e.g., second panel) articulates a change of degree (e.g., between 0° and 90°) when activated/operated to change, translate, rotate, pivot, or otherwise move the part of extension 512, for example change a panel angle. In some cases the cable is attached to steering (e.g., steering wheel or digitally controlled), and mechanically pulls or raises extension 512 or the part of extension 512 as the steering (e.g., steering wheel) deviates from center (e.g., turned off center). Extension 512 or a part of extension 512 can also be raised when the brake or other braking mechanism or force is pressed or exerted on the vehicle, for example by pression on the loop of wire.

Where disorganized or separated flow of air begins in or around a vehicle, a sharp separation of two organized vortices is formed meeting at or about the top the vehicle (e.g., roof peak, above vehicle, above extension, above roof panel or other panels, etc.). Separated and upward lift from a downward sloping aft vehicle is replaced by an energized vortex wake going upward. It is contemplated that upward lift is replaced with downforce by use of the inventive subject matter. For example, an adjustable virtual boat-tail of organized vortex collisions can be formed with downforce spoiling lift plus mirrors.

FIG. 7 depicts a plan view of vehicle 700 having body 710, including extension 712 and three longitudinal roof and hatchback crosswind spoilers 714, 716, and 718 used together. This depiction balances the trade between lift and downforce (e.g., via extension 712), as well as balancing chaotic airflow and organized airflow (e.g., via some or all of crosswind spoilers 714, 716, and 718). Spoilers 714, 716, or 718 can be adapted to replace antenna or use mounting holes for antennas on the roof of vehicle 700. Spoilers 714, 716, or 718 can further be adapted to existing rails, door seams, frames, or other structures on the roof or sides of vehicle 700. Adding bend or tilt functionality to all or parts of extension 712 or spoilers 714, 716, or 718 provides active aerodynamics to enhance braking, change downforce, increase safety, and balance drag and efficiency.

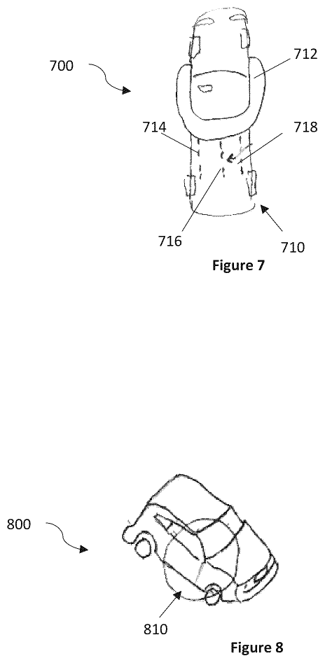

FIG. 8 depicts vehicle 800 with circled portion 810.

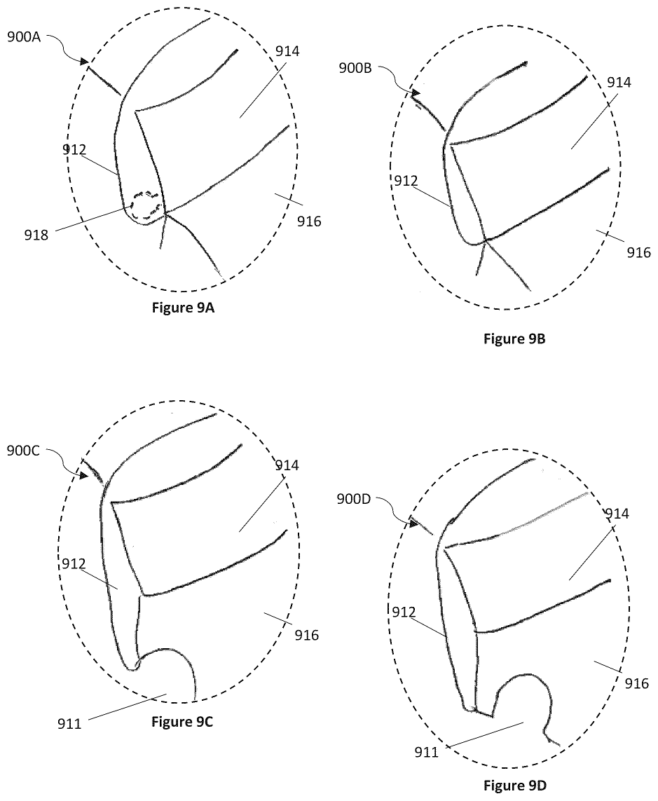

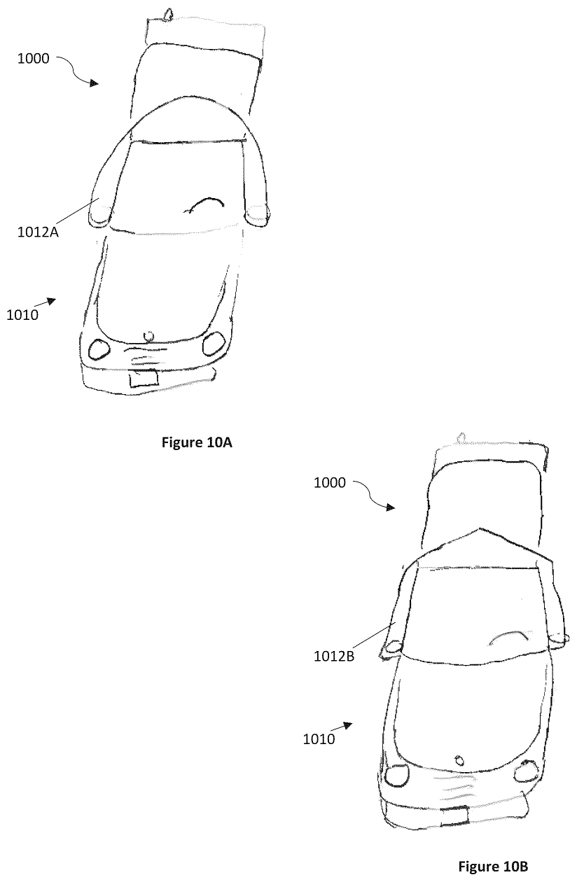

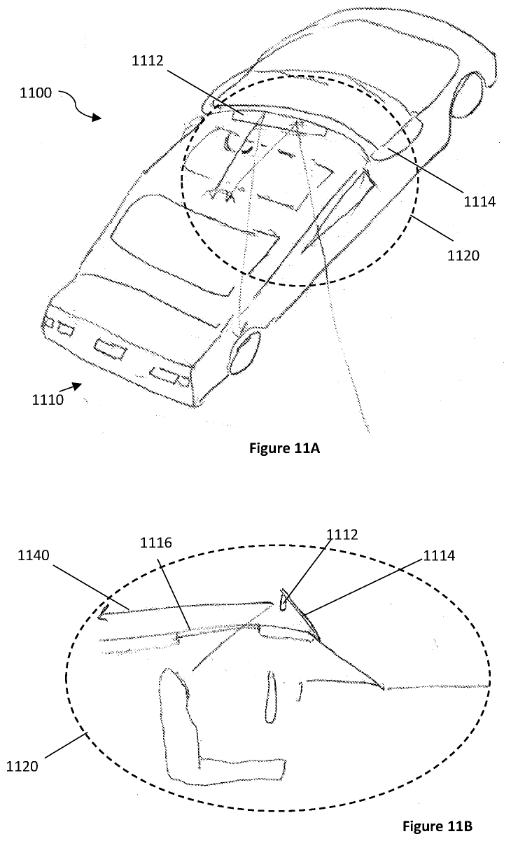

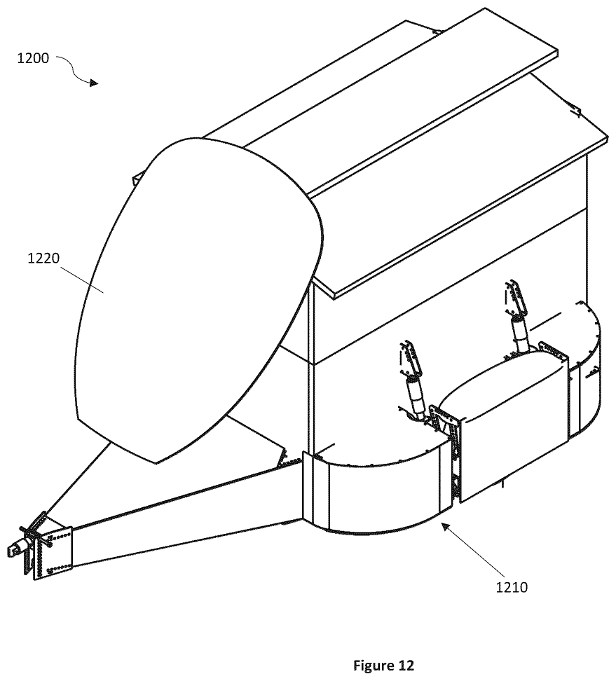

FIGS. 9A-9D depicts an enlarged view of portion 810 from FIG. 8, depicting a variety of variations of ways to terminate the lower bottom of the windshield extension 912 shown in relation to the conventional location of side mirror 918, hood 916, and windshield 914. FIG. 9A depicts view 900A with extension 912 over mirror 918 (see dashed lines of mirror 918). FIG. 9B depicts view 900B with no side mirror, and the edge of extension 912 closer to the side edge of windshield 914. FIG. 9C depicts view 900C with no side mirror, and extension 912 extending toward wheel well 911. FIG. 9D depicts view 900D with no side mirror, and extension 912 extending from the bottom edge of vehicle 800 at a point rearward from wheel well 911.

FIGS. 10A-10B depicts vehicle 1000 with body 1010 and two general embodiment in curved-extension 1012A and peaked-extension 1012B.

FIG. 11A depicts vehicle 1100 with body 1110, rear view mirror 1112 behind the windshield extension 1114 and region 1120 encircled. Mirror 1112 extends wider than a conventional mirror (e.g., 30%, 40%, or more than 50% width of vehicle) and can be curved. FIG. 11B depicts a side view of region 1120, showing mirror 1112 positioned on extension 1114, viewing panel 1116 allowing the driver to see behind and to the sides of the vehicle using mirror 1112 (depicted as viewing arrow 1140).

FIG. 12 depicts trailer 1200 or other vehicle with body 1210 and front windshield or plate 1220. Plate 1220 provides downward force on the trailer as the trailer moves.

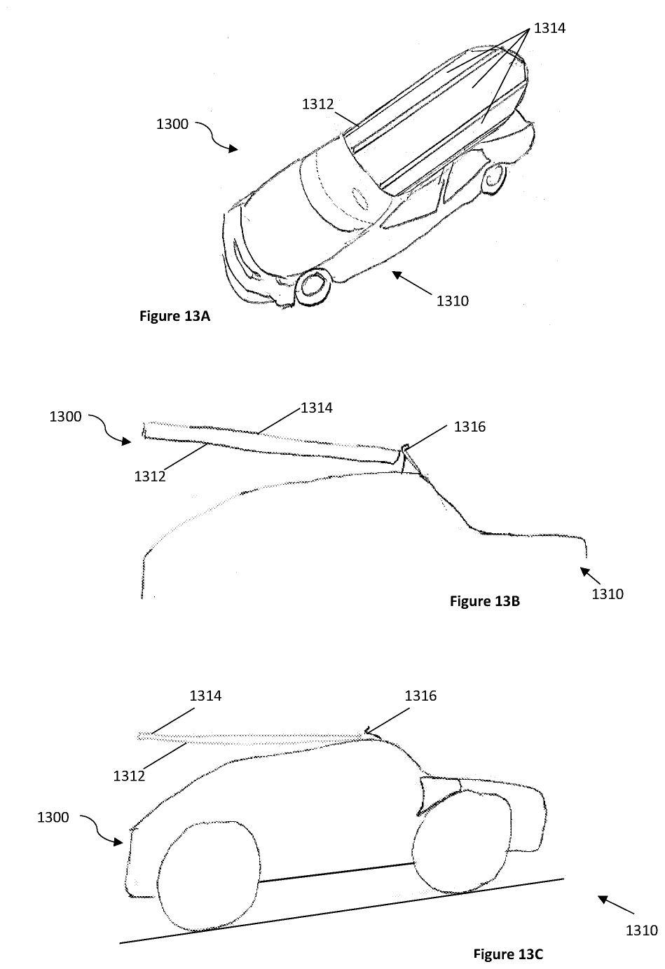

FIGS. 13A-13C depict vehicles with adjustable roof frames. FIG. 13A depicts a three quarter above view of vehicle 1300 with body 1310 having a hinged roof frame 1312 with angle adjusters that holds the solar panels or other surfaces 1314 that form the downforce generating surface that may be attached to the roof top or window by a flexible metal braid or soft metal or plastic or conventional hinge. FIGS. 13B-13C depict side views of vehicle 1300 with body 1310 and adjustable roof frame 1312 for holding or supporting solar panels or surfaces 1314. Frame 1312 is adjustable by hinge 1314 or other mechanisms, and FIGS. 13B and 13C show frame in two different positions between a 0°-10° incline (FIG. 13C) and a 10°-30° incline (FIG. 13B), though it is contemplated hinge 1316 or other mechanism permits frame 1314 to adjust incline between 0° and 90°. It should be appreciated that solar cells of known technologies can be integrated into, supported by, mounted on, or applied to surfaces of vehicle 1300, body 1310, frame 1312, or surfaces 1314.

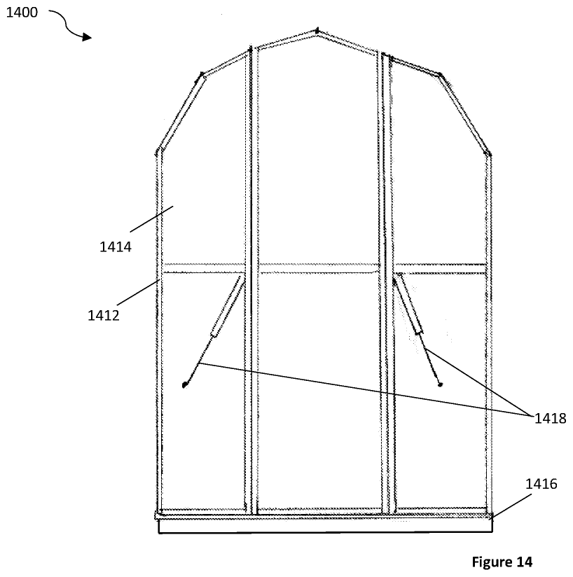

FIG. 14 depicts a view of hinged roof frame 1400 with frame 1412, panels or surface gaps 1414, hinge 1416, and angle adjusters or supports 1418. Frame 1400 holds solar panels or other surfaces in gaps 1414 to generate electricity (e.g., when solar) as well as form a downforce generating surface. Frame 1400 attaches to the roof top or window of a vehicle by hinge 1416, for example a flexible metal braid or soft metal or plastic or conventional hinge. Hinges that are stainless flat braid (or otherwise flexible, e.g., soft metal, plastic, combinations, etc.) accommodate curvatures of vehicle surfaces and enables adaptable installation of frame 1400 to different vehicles or mounting surfaces.

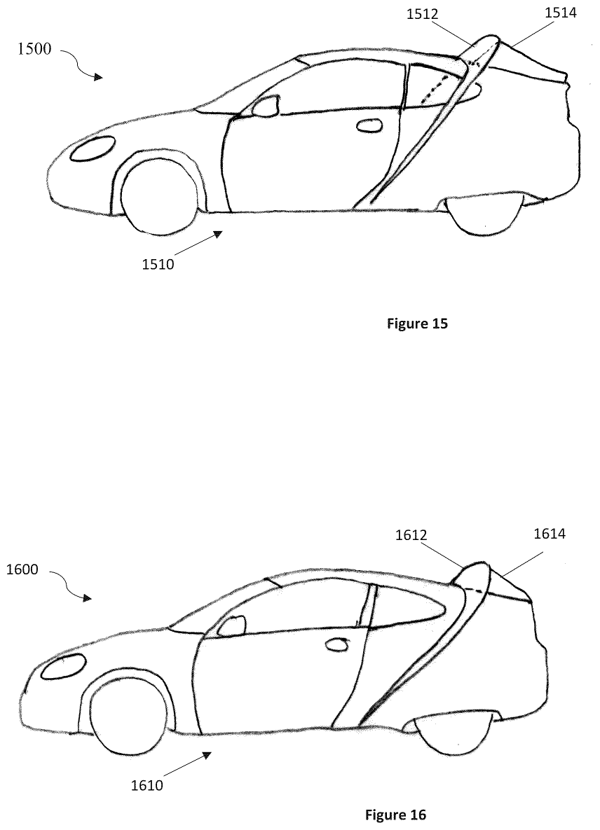

FIG. 15 depicts a side view of vehicle 1500 having body 1510 and an elongated collar 1512 extending from the side base of the vehicle up and rearward toward the back of the vehicle and over the rear roof/window, with a structure 1514 supporting the collar 1512 extending from the top of the collar toward the back of the vehicle. Of note, the collar 1512 extends over the passenger/second row windows at the side of the vehicle.

FIG. 16 depicts a side view of a vehicle 1600 having body 1610 and an elongated collar 1612 extending from the side base of the vehicle up and rearward toward the back of the vehicle and over the rear roof/window, with a structure 1614 supporting the collar 1612 extending from the top of the collar toward the back of the vehicle. Of note, the collar 1612 extends over the side body of the vehicle rather than the side windows.

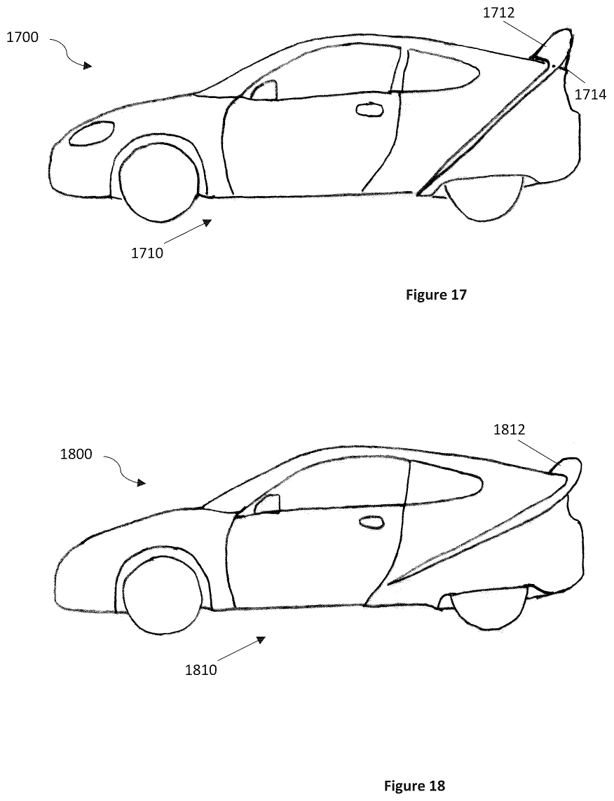

FIG. 17 depicts a side view of a vehicle 1700 having body 1710 and an elongated collar 1712 extending from the side base of the vehicle near the rear wheel well, up and back toward the back of the vehicle 1700 and over the trunk, with a structure 1714 supporting collar 1712 extending from the top of the collar toward the trunk. Of note, collar 1712 extends over the side body at an abrupt angle (e.g., between 80° and 30°) of the vehicle 1700 and ends at the back of the vehicle.

FIG. 18 depicts a side view of vehicle 1800 having body 1810 and an elongated collar 1812 extending from the side base of the vehicle 1800 near the door frame, up and back toward the back of the vehicle and over the trunk. Of note, the collar 1812 extends at a flatter angle (e.g., between 10° and 60°) toward the rear edge of the trunk compared to collar 1712 of FIG. 17.

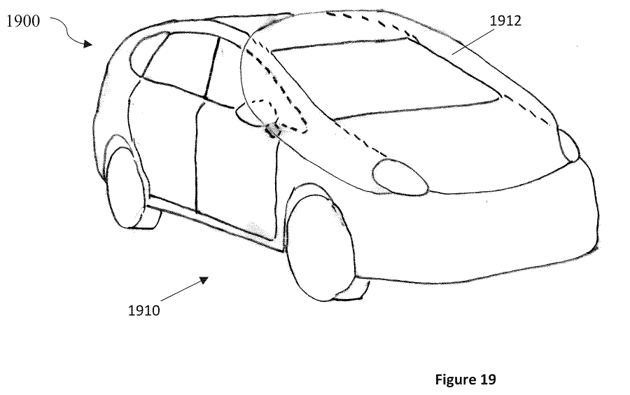

FIG. 19 depicts a front perspective view of vehicle 1900 having body 1910. Extension 1912 is wider than the body and is coupled with the vehicle around the bottom of the headlight. In this embodiment extension 1912 extends from both the hood and the windshield of vehicle 1900, as part of a single plane or otherwise flush with the hood and windshield.

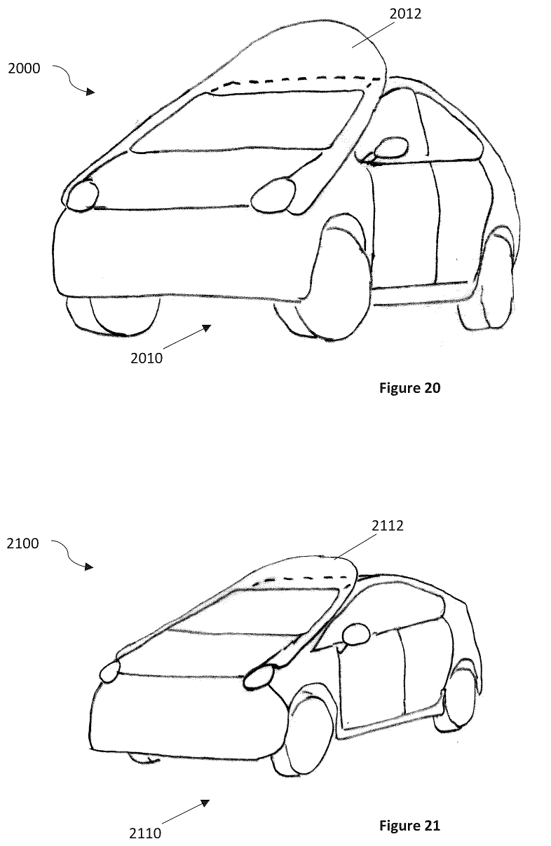

FIG. 20 depicts a front perspective view of vehicle 2000 having body 2010. Extension 2012 is generally planar with the hood and windshield of vehicle 2000, and flairs outward at the top of the vehicle. Extension 2010 is aligned with the front pillars of vehicle 2000 (e.g., not wider than the body), and couples with the vehicle toward the bottom of the headlights. Embodiments are contemplated where extension 2012 hangs over or extends beyond body 2010 or is separated or separates from (e.g., raised from) body 2010.

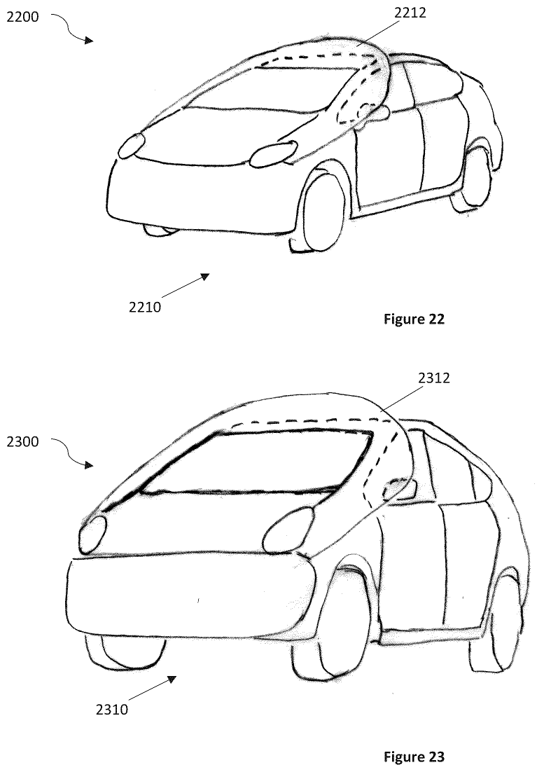

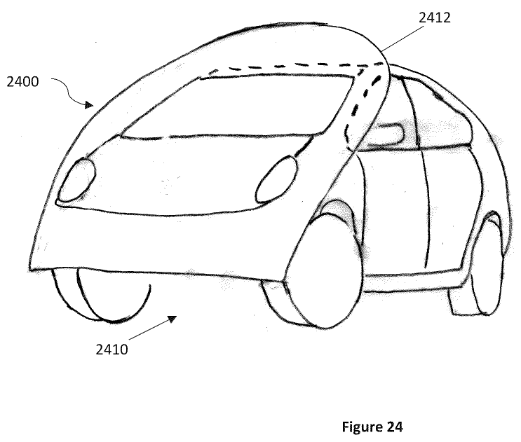

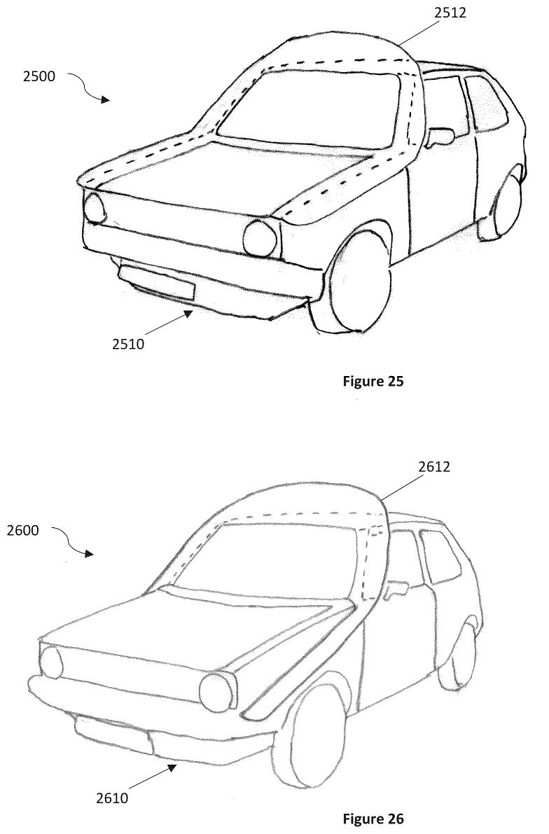

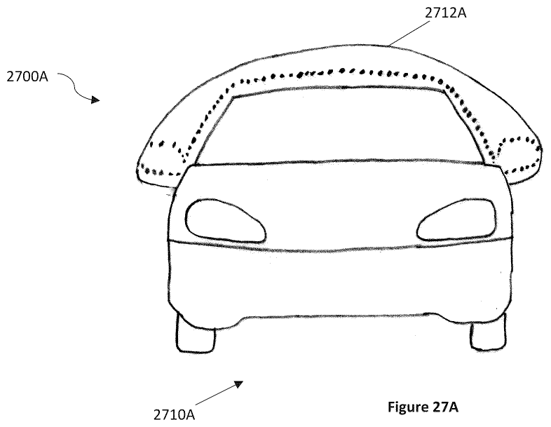

FIG. 21 depicts a front perspective view of vehicle 2100 having body 2110 and extension 2112. Vehicle 2100 is similar to vehicle 2000 of FIG. 20, noting extension 2112 couples with vehicle 2100 toward the top of the headlights and does not flair upward from the roof of the vehicle as much as extension 2012 much.

FIG. 22 depicts a front perspective view of vehicle 2200 with body 2210. Extension 2212 is wider than the body (extends beyond the front pillars) and attaches toward the bottom of the headlights or vehicle 2200.

FIG. 23 depicts a front perspective view of vehicle 2300 having body 2310. Extension 2312 extends beyond the front pillars and couples with the vehicle at the bumper below the headlights.

FIG. 24 depicts a front perspective view of vehicle 2400 having body 2410. Extension 2412 mates with the windshield and hood, extends past the body/front pillars, around headlights, and extends fairly low on the front of the vehicle, to the front edge. In some embodiments, extension 2410 is a solid panel with a cutout matching and mating with the hood and windshield space of vehicle 2400. In some embodiments, extension 2410 is a comprehensive piece including an integrated windshield, integrated hinged hood, and headlights, and completely replaces the stock or preexisting hood, windshield, or headlights portion of a vehicle.

FIG. 25 depicts a front perspective view of vehicle 2500 having body 2510. Extension 2512 mates with the hood and windshield, bending at the seam between the two, and extends beyond the pillars of vehicle 2500. Extension 2512 can include a hinged portion that roughly aligns with the seam between a hood and a windshield portion of a vehicle, which permits extension 2512 to adjust and fit multiple different body styles or geometries of vehicles. In some embodiments, extension 2512 includes two separate panels, one for fitting to the hood portion of the vehicle and the other for fitting to the windshield portion of the vehicle, which in turn can be fastened together or remain separate from each other when fitted to the vehicle.

FIG. 26 depicts a front perspective view of vehicle 2600 having body 2610. Extension 2612 mates with the windshield, but is not flush with the hood, and extends past the body/front pillars. Extension 2612 can include a hinge or comprise two separate or joined panels as described above. It should be appreciated that FIGS. 25 and FIGS. 26 show a bent version of an extension (e.g., single panel with bend, two panels joined at an angle, multiple panels forming extension 2612 or 2512, etc.). Extensions can extend all the way to the front of the vehicle. Such bent extensions can be applied to vehicles with sharper angles, transitions, or curves between a windshield portion and a front hood portion, or a more abrupt or vertical windshield and a more horizontal or flat hood.

Contemplated vehicles may include a windscreen and hood in a combined plane, with panels extending further therefrom to increase the downforce generated when moving forward. Extension and panels are further contemplated to trip the air layer around the vehicles with a sharp edge to intentionally create a vortex steered upward around the vehicle to the roof and upward to eventually collide with the same vortex from the other side of the vehicle. This concept can be adapted or applied to both co-planar hood and windshield conformations or bent 2-lane conformations. Tripping the air flow and starting a downforce vortex more forward or frontward on the vehicle (or all the way forward) can be desired.

In some embodiments adjustable or steerable panels, fins, or vanes can be used to increase or decrease downforce or otherwise improve or change aerodynamics of a vehicle.

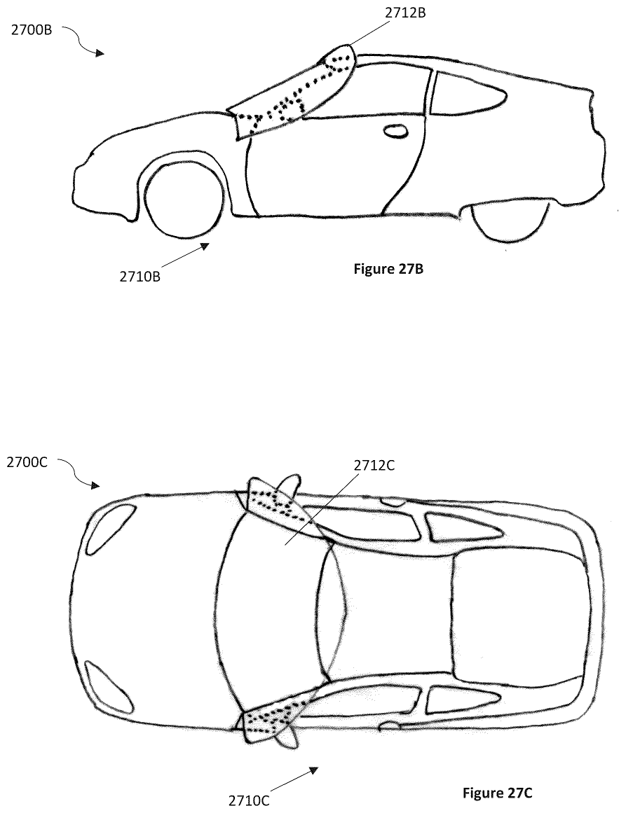

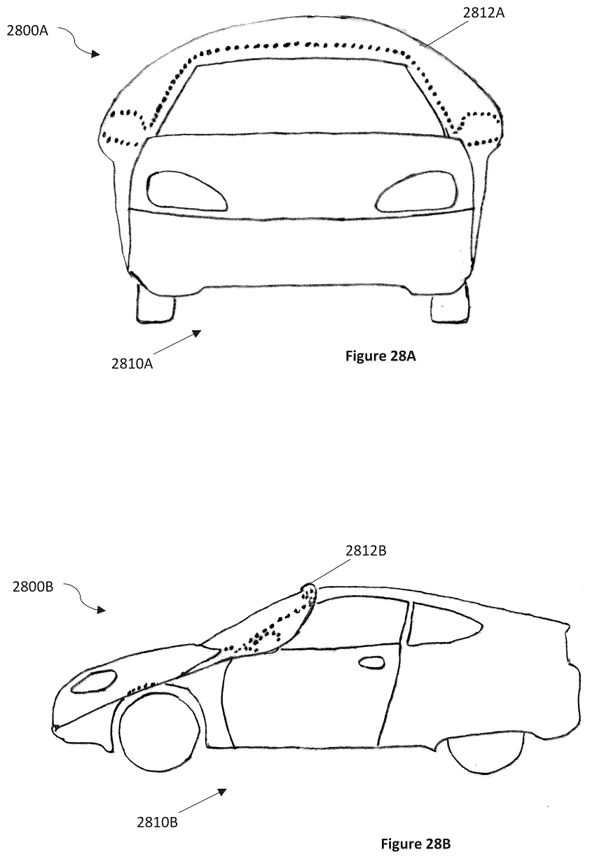

FIG. 27A depicts a front view of vehicle 2700A having body 2710A, with extension 2712A extending wider than the vehicle, starting below the windshield and over the top of the vehicle.

FIG. 27B depicts a side view of vehicle 2700B having body 2710B, with extension 2712B extending wider than the vehicle, starting below the windshield and over the top of the vehicle. Note extension 2712B is mostly planar/flat or curved around the windshield, but flairs upward and away from the roof of vehicle 2700B toward the top of the extension.

FIG. 27C depicts a top view of vehicle 2700C having body 2710C, with extension 2712C extending wider than the vehicle, starting below the windshield and over the top of the vehicle. Extension 2712C curves toward a point or peak at the top of the extension.

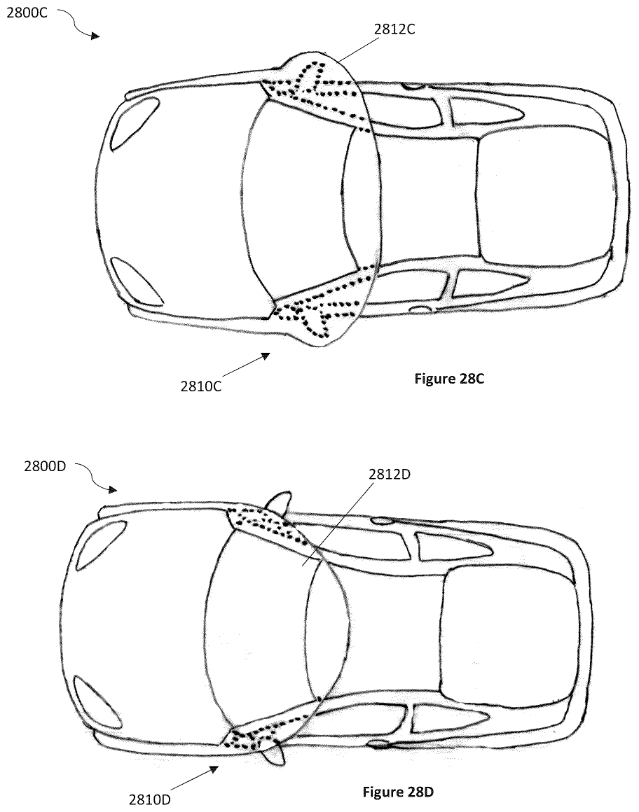

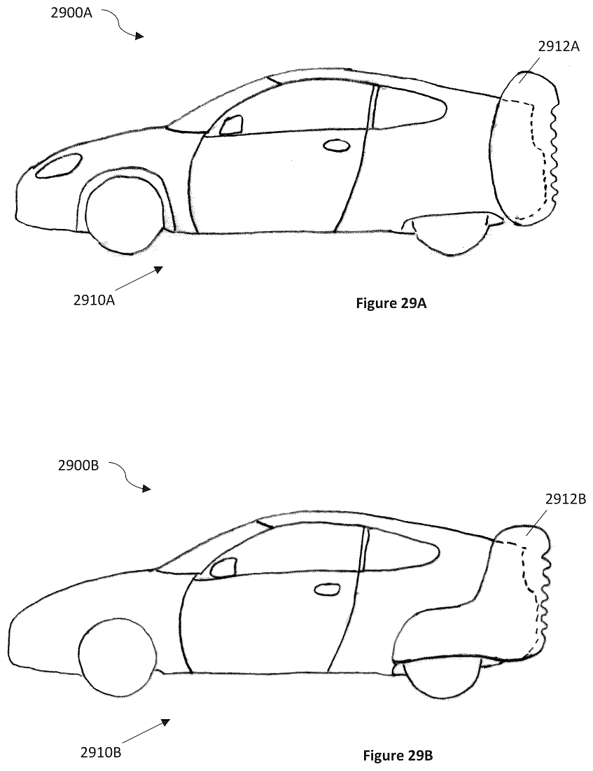

FIG. 28A depicts a front view of vehicle 2800A having body 2810A, with extension 2812A extending wider than the vehicle, starting below the headlights, extending over the top of the vehicle and bubbling around/over the side view mirrors.

FIG. 28B depicts a side view of vehicle 2800B having body 2810B, with extension 2812B extending wider than the vehicle, starting below the headlights and extending near the top of the vehicle.

FIG. 28C depicts a top view of vehicle 2800C having body 2810C, with extension 2812C bubbling wider than the vehicle, starting below the headlights, extending over the top of the vehicle and around or over the side view mirrors. Extension 2812C flattens at the top of the extension. In some aspects, the bubbling of 2812C denotes the roundness of the extension covering or otherwise extending from, over, or past body 2810C or features (e.g., mirrors, antenna, etc.) of vehicle 2800C. Bubbling is also used to denote transparency or clearness of extension 2812C, for example to allow a driver of vehicle 2800C to see through extension 2812C. As applied, “bubbling” can describe the noted shape or transparency, or both.

FIG. 28D depicts a top view of vehicle 2800D having body 2810D, with extension 2812D extending wider than the vehicle, starting below the headlights and extending over the top of the vehicle but not bubbling around/over the side view mirrors. Extension 2812D extends to a peak at the top of the extensions.

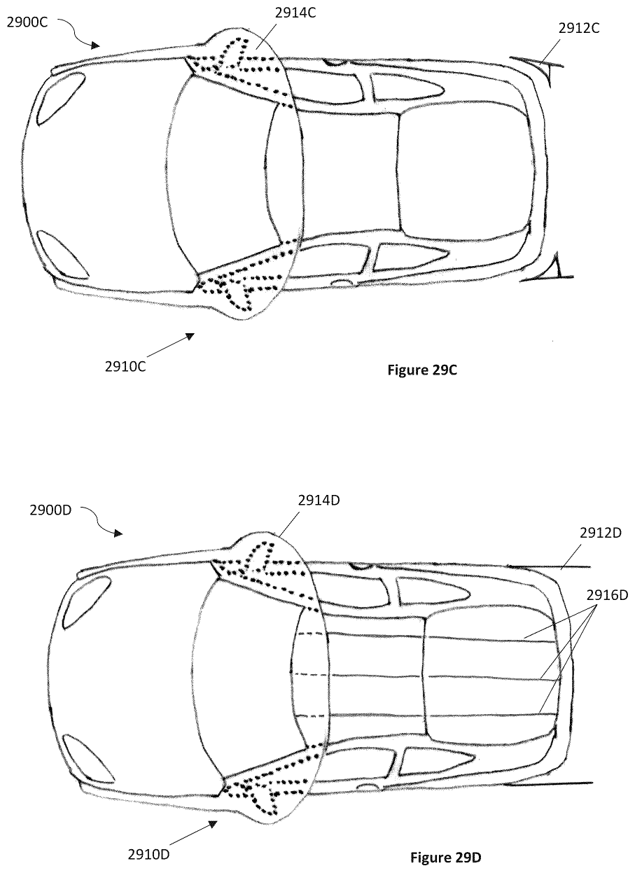

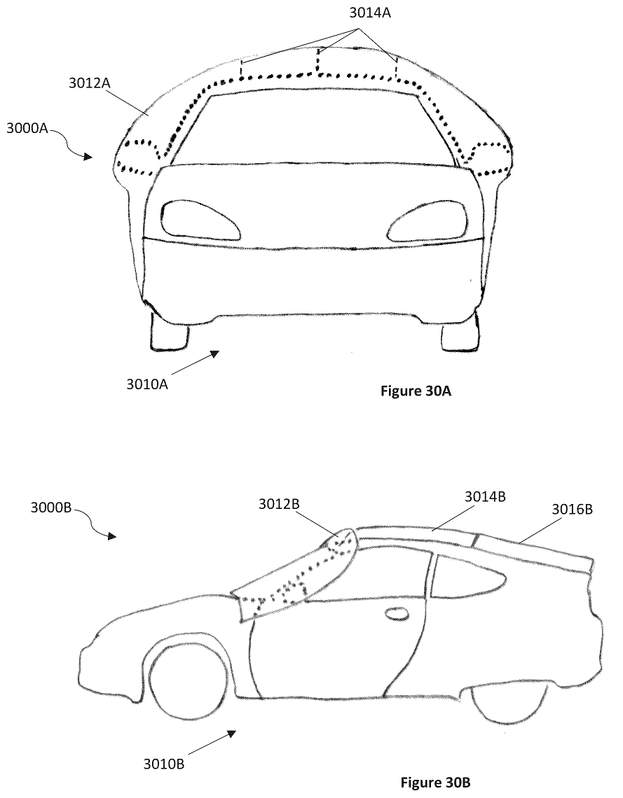

FIG. 29A depicts a side view of vehicle 2900A having body 2910A, with fin 2912A covering the rear portion of the vehicle.

FIG. 29B depicts a side view of vehicle 2900B having body 2910B, with fin 2912B covering the rear portion of the vehicle and extending from or over the rear wheel well. Fin 2912B has a rounded top with serrated trailing edge.

FIG. 29C depicts a top view of vehicle 2900C having body 2910C, with a front extension 2914C and a fin 2912C at the rear portion of the vehicle. Fin 2912C has a rounded top with serrated trailing edge.

FIG. 29D depicts a top view of vehicle 2900D having body 2910D, with a front extension 2914D and a fin 2912D from the side of the rear portion of the vehicle 2900D, and three fins 2916D along the top of the vehicle.

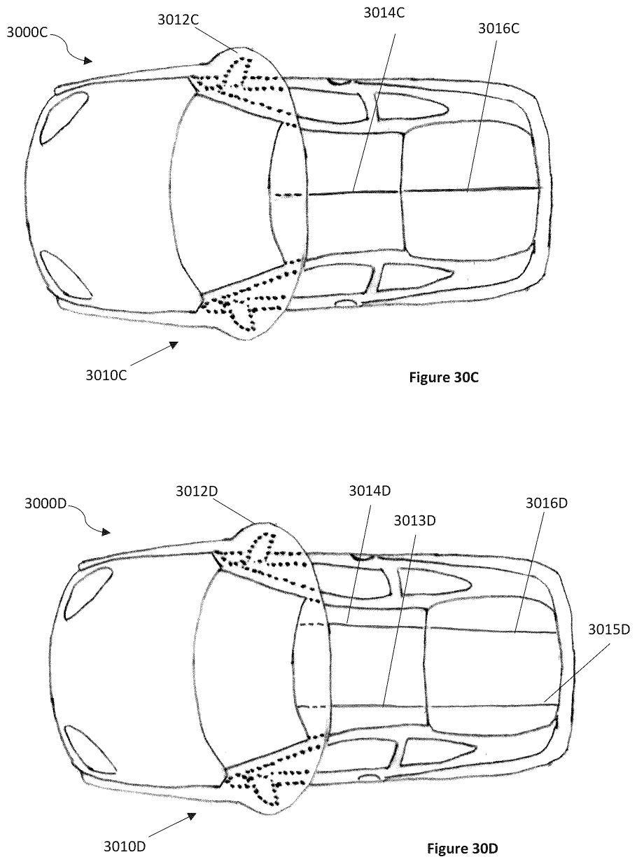

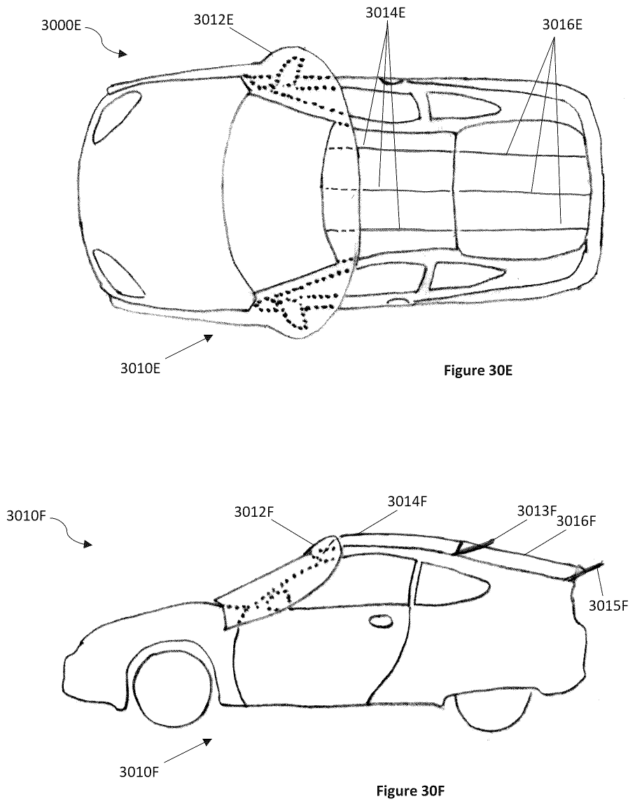

FIG. 30A depicts a front view of vehicle 3000A having body 3010A, with extension 3012A extending from below the headlights, wider than the body, and over the top of the car. Three fins 3014A extend from extension 3012A and along the roof of the vehicle 3000A.

FIG. 30B depicts a top view of vehicle 3000B having body 3010B, with extension 3012B extending from below the windshield, wider than the body, and over the top of the vehicle. Fin 3014B couples with extension 3012B and extends along the roof of the vehicle. Fin 3016B further couples to fin 3014B.

FIG. 30C depicts a top view of vehicle 3000C having body 3010C, with extension 3012C extending from below the headlights, wider than the body, and over the top of the vehicle. Fin 3014C couples with extension 3012C and extends along the roof of the vehicle. Fin 3016C further couples to fin 3014C.

FIG. 30D depicts a top view of vehicle 3000D having body 3010D, with extension 3012D extending from below the headlights, wider than the body, and over the top of the car. Two fins 3013D and 3014D couple with extension 3012D and extend along the roof of the vehicle. Fins 3015D and 3016D further couple with fins 3013D and 3014D.

FIG. 30E depicts a front view of vehicle 3000E having body 3010E, with extension 3012E extending from below the headlights, wider than the body, and over the top of the car. Three fins 3014E couple with extension 3012E and extend along the roof of the vehicle. Three fins 3016E further couple with fins 3014E.

FIG. 30F depicts a side view of vehicle 3000F having body 3010F, with extension 3012F extending from below the windshield, wider than the body, and over the top of the car. Fin 3014F is coupled to extension 3012F and extends along the roof of the vehicle. Fin 3016F is coupled to fin 3014F. Two spoilers 3013F and 3015F are on the roof and at the back of the vehicle.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although cach embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A kit to adjust aerodynamics of a vehicle having a body, a front hood, and a windshield, comprising:
a first panel adapted to couple with the vehicle at the front hood, the first panel extending away from the front hood for a length at least 5% of a width of the front hood;
a second panel adapted to couple with the vehicle about the windshield, the second panel extending away from the windshield for a length at least 5% of a width of the windshield.

2. The kit of claim 1, wherein the second panel is an extension of the first panel.

3. The kit of claim 1, wherein the first panel is coupled to the second panel at a boundary corresponding to a seam between the front hood and the windshield.

4. The kit of claim 1, wherein the first panel is co-planar with the second panel.

5. The kit of claim 1, wherein the first panel couples to at least one of an exterior surface of the body adjacent to the front hood, a front wheel well of the vehicle, or a headlight of the vehicle.

6. The kit of claim 1, wherein the first panel replaces the front hood of the vehicle.

7. The kit of claim 1, wherein the second panel comprises a transparent panel, and wherein the transparent panel replaces the windshield of the vehicle.

8. The kit of claim 1, wherein the second panel comprises a hinge allowing a top portion of the second panel to rotate away from the top portion of the vehicle.

9. The kit of claim 1, wherein the first panel comprises a gap configured to fit the body of the vehicle about the front hood.

10. The kit of claim 1, wherein the second panel extends over a side view mirror of the vehicle.

11. The kit of claim 1, wherein the second panel extends over and away from a roof of the vehicle at an angle of at least 10°.

12. A kit for adapting a vehicle to increase downward force of the vehicle moving in a motive vector, comprising:
a first panel adapted to couple to the vehicle, wherein the first panel has a primary surface with a normal vector within at least 60° of the motive vector when coupled to the vehicle;
a support coupled to the first panel, wherein an end of the support is configured to further couple to the vehicle.

13. The kit of claim 12, wherein the first panel is configured to couple to the vehicle at one of a hood, a trunk, a door frame, a windshield, or a roof of the vehicle.

14. The kit of claim 12, wherein the end of the support is configured to couple to the vehicle at one of a hood, a trunk, a door frame, a windshield, or a roof of the vehicle.

15. The kit of claim 12, wherein the first panel is configured to rotatably couple to the vehicle.

16. The kit of claim 12, wherein the support is configured to adjustably couple to the vehicle providing an angle 5° to 60° between the first panel and a surface of the vehicle.

17. The kit of claim 12, wherein the first panel is configured to couple about a windshield of the vehicle and extend over a roof of the vehicle, and furthering comprising a second panel configured to couple to one of a roof, a rear end, or a front hood of the vehicle.

18. A method of modifying a vehicle to adjust vehicle aerodynamics, comprising:
coupling a first panel about a windshield of the vehicle, wherein the first panel comprises a surface extending away from the windshield; and
coupling a second panel to at least one of the front hood or a roof of the vehicle, wherein the second panel is within 20° of parallel to the first panel.

19. The method of claim 18, further comprising coupling a support to one of the first panel or the second panel, and further coupling an end of the support to the vehicle.

20. The method of claim 18, further comprising coupling a fin to a roof or a rear end of the vehicle.
